(19) United States
(12) Patent Application Publication
(10) Pub. No.: US 2013/0201421 A1
(43) Pub. Date: Aug. 8, 2013

(54) BACK PLATE STRUCTURE WITH EASY REPLACEMENT OF LED STRIPS AND LCD HAVING THE SAME

(71) Applicant: Ya-Jun Yu, Shenzhen (CN)

(72) Inventor: Ya-Jun Yu, Shenzhen (CN)

(21) Appl. No.: 13/510,159

(22) PCT Filed: Mar. 7, 2012
(86) PCT No.: PCT/CN2012/072016

§ 371 Date: May 16, 2012

(30) Foreign Application Priority Data
Feb. 7, 2012 (CN) 201210026567.7

(51) Int. Cl. G02F 1/1333; F21V 21/00

(52) U.S. Cl. 349/58; 248/309.1

(57) ABSTRACT

A back plate structure with easy replacement of LED strips and a liquid crystal display having the same are provided. The back plate structure includes a plurality of locking members; a fixed type metal back plate disposed with a plurality of bolts; and a detachable metal back plate, including a plurality of protrusions and a plurality of grooves. The plurality of protrusions are located on lateral sides of the detachable metal back plate and corresponding to the positions of openings of a frame of the LCD so as to allow the protrusions to insert into the openings of the frame, and the grooves are corresponding to the bolts so as to allow the bolts to insert into the grooves, and the fixed type metal back plate and the detachable metal back plate are fixed together through the locking members.

### FIELD OF THE INVENTION

The present invention relates to a liquid crystal display (LCD), and more particularly to a back plate structure with easy replacement of LED strips.

### BACKGROUND OF THE INVENTION

Back light unit is one of LCD key components. Because the LCD panel itself cannot emit light, the function of the back light unit is to provide light with sufficient brightness and uniform distribution, so as to allow the LCD to display images. Currently, the LCDs are widely used in the electronic products with high growth potential such as monitors, laptop computers, digital cameras, and projectors; therefore, the demands for the back light unit and related components keep growing in numbers. In addition, due to its characters of small in volume, long lifespan, low power consumption, short response time and shock resistance, the LED are widely used for lighting or back light to replace the conventional lighting devices such as tungsten lamps, incandescent lamps or cold cathode fluorescent lamp.

For most of the back light units, a light-blocking belt is arranged transversely to cover the LED strips and the wires of the LED strips, so as to fix the LED strips and the wires of the LED strips on the lateral sides of a guide plate. In addition, the back side of the guide plate is further disposed with a reflecting plate in order to focus all the light emitted from the LEDs to the front direction. However, the above-mentioned guide plate has the following disadvantages in practice: in the above-mentioned guide plate, when a sealant is filled in the LED strips, the LED strips and the guide plate will be sealed. If some of the LED strips have to be replaced, the LED strips may be damaged and deformed and unable to be used anymore after replacing, and the light emitting conditions of the guide plate may be changed as well, which leads to cost increases. In addition, if the LED strip must be replaced because of failure lamps, the back light unit has to be disassembled, which leads to wastes of rework time and labor force and decrease of productivity. Moreover, the prices of one-piece back plate made of SECC galvanized steels and aluminum extrusion materials used are quite expensive such that the total cost is difficult to be reduced.

### SUMMARY

The present invention is intend to solve the above-mentioned problems, such that a back plate structure with easy replacement of LED strips and an LCD having the same are provided, in which a detachable back plate is used when the LED strips are required to be replaced. Therefore, the failed LED strip can be replaced by simply detaching the detachable back plate, so as to save the time of disassembling the back light unit and achieve the purpose of reducing manufacturing cost.

The technology means adopted for solving the above-mentioned problems includes: to provide a back plate structure with easy replacement of LED strips and an LCD having the same, which comprises: a plurality of locking members; a fixed type metal back plate disposed with a plurality of bolts; and a detachable metal back plate including a plurality of protrusions and a plurality of grooves. The protrusions are located on the lateral sides of the detachable metal back plate and corresponding to the positions of openings of a frame of the LCD so as to allow the protrusions to insert into the openings of the frame, and the grooves are corresponding to the positions of bolts so as to allow the bolts to insert into the grooves. The fixed type metal back plate and the detachable metal back plate are fixed together through the locking members.

In one embodiment of the present invention, the fixed type metal back plate is made of a SECC galvanized steel.

In one embodiment of the present invention, the detachable metal back plate is made of an aluminum extrusion material.

In one embodiment of the present invention, the detachable metal back plate is disposed with a lighting strip thereon.

In one embodiment of the present invention, the groove is a track groove.

Compared with the conventional technology, the back plate of the back light unit in the present invention is assembled by several parts. The part close to the lighting source is made of an aluminum extrusion material instead of a SECC galvanized steel. The part far away the lighting source is made of a SECC galvanized steel which has high strength and relatively low cost. The aluminum extrusion type back plate can be fixed with the fixed type metal back plate together by screws through the bottom of the fixed type metal back plate in which no lighting source is disposed on the middle of the back plate, such that the LED strips can be easily replaced and attached to the aluminum extrusion type back plate. Then, the LED strips and the back plate can insert into the back plate unit from a back side thereof and engaged with the openings in the lateral side of the bezel on the frame for fixing position. The bezel of the back plate, which is at the same side of the lighting source, has a supporting arm to insert into the small holes of the aluminum extrusion type back plate to increase the structure strength of the back plate unit.

### BRIEF DESCRIPTION OF THE DRAWINGS

FIG. 1 is a perspective view of a back plate structure of an LCD according to the present invention.

FIG. 2 shows a combined view of the fixed type metal back plate and the detachable metal back plate according to the present invention.

FIG. 3 is a perspective view showing that the protrusion of the detachable metal back plate is released from the opening of the frame of the LCD.

FIG. 4 is a drawing showing a relative position of the detachable metal back plate and the fixed type metal back plate during disassembling.

FIG. 5 is a perspective view showing that the detachable metal back plate is released from the LCD.

### DETAILED DESCRIPTION OF THE EMBODIMENTS

Reference will now be made in detail to the preferred embodiment of the present disclosure, examples of which are illustrated in the accompanying drawings.

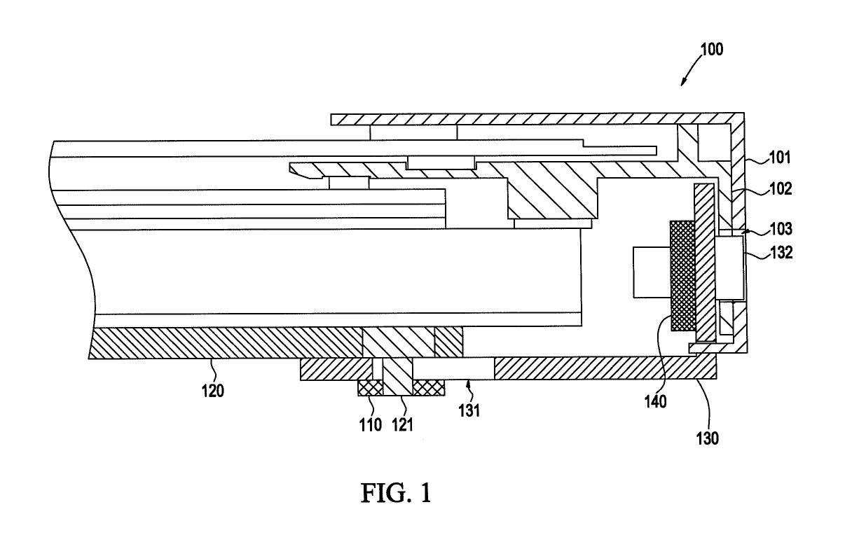

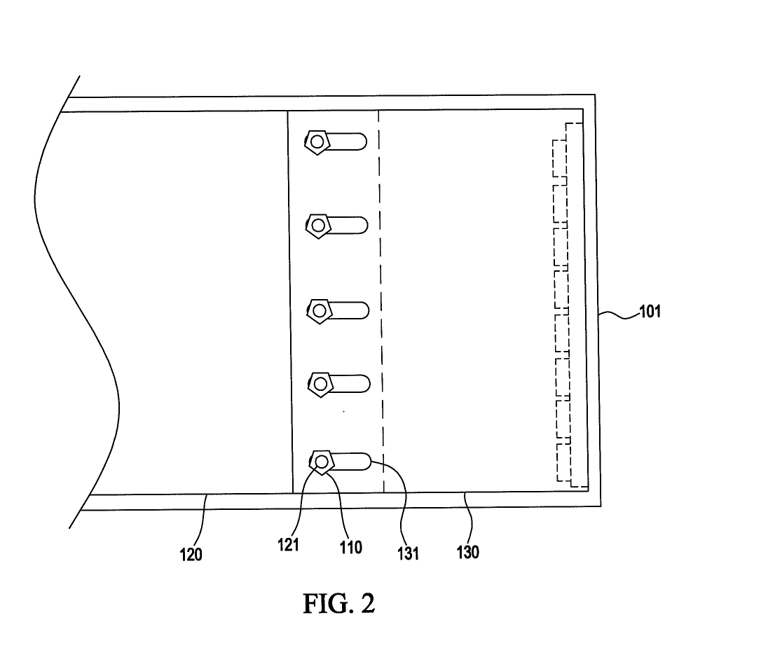

Please refer to FIGS. 1 and 2, a back plate structure of an LCD according to the present invention comprises: a plurality of locking member 110, a SECC back plate 120, and an aluminum (Al) extrusion type back plate 130. The SECC back plate 120 is disposed with a plurality of bolts 121. The Al extrusion type back plate 130 comprises a plurality of track grooves 131 and a plurality of protrusions 132, and the plurality of protrusions 132 are located on the lateral sides of the Al extrusion type back plate 130 and corresponding to the positions of a frame 102 and openings of bezel 102 of a LCD 100, such that the protrusions 132 can insert into the frame 102 and the openings 103 of the bezel 102. The track grooves 131 are corresponding to the positions of the bolts 121; therefore, the bolts 121 can insert into the track grooves 131, and the fixed type metal back plate 120 and the Al extrusion type back plate 130 can be fixed together by using the plurality of the locking members 131.

The characteristic feature of the present invention lie in that: a one-piece SECC back plate is divided into two parts: a SECC back plate 120 and an aluminum (Al) extrusion type back plate 130. A plurality of bolts 121 is riveted on an area of the SECC back plate 120 overlapped with the Al extrusion type back plate 130, and the head of the bolt 121 is pointing downward. In addition, a plurality of track grooves is formed on the area of the Al extrusion type back plate 130 overlapped with the SECC back plate 120 by a punch method. After LED strips 140 are attached to the Al extrusion type back plate 130, a locking member 110, preferably a nut, is used to tighten the bolt 121 so as to fix the SECC back plate 120 and the Al extrusion type back plate 130 together. Please see FIG. 2 for details.

A plurality of protrusions 132 is disposed on the Al extrusion type back plate 130 corresponding to the positions of the LED strips 140. A frame 101, a bezel 102 and a plurality of opening 103 therein corresponding to the positions of the protrusion 132 are used in order to engage with the protrusion 132, so as to fix the Al extrusion type back plate 130. In addition, in the bottom position of the Al extrusion type back plate 130 close to the lighting source, a plurality of small holes (or a trench) is disposed therein, and the bezel 102 arranged at the same side is disposed with a supporting arm. The supporting arm can insert into the small holes (or the trench), so as to enhance the structure strength.

After the LED strips are locked on the Al extrusion type back plate 130, the Al extrusion type back plate 130 can insert into the LCD 100 from the bottom to the top thereof. When the Al extrusion type back plate 130 is connected with the SECC back plate 120, the Al extrusion type back plate 130 can move to the right direction through the track groove 131 until the plurality of protrusions 132 of the Al extrusion type back plate 130 is inserted into the frame 101 and the openings 103 of the bezel 102. Then, the supporting arm of the bezel 102 is inserted into the plurality of small holes (or the trench) at the bottom portion of the LED strips on the Al extrusion type back plate 130. And then, the locking member (nut) 110 is used for fixing the position of the Al extrusion type back plate 130.

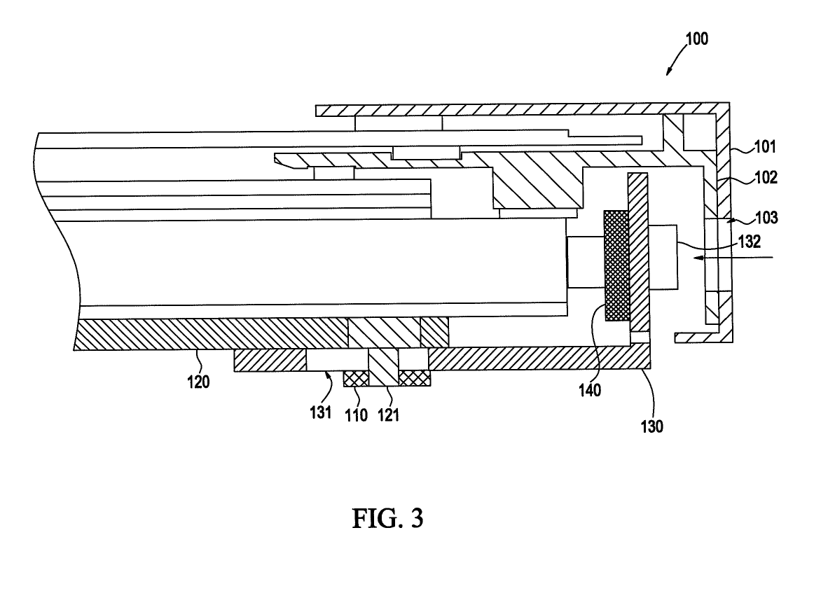

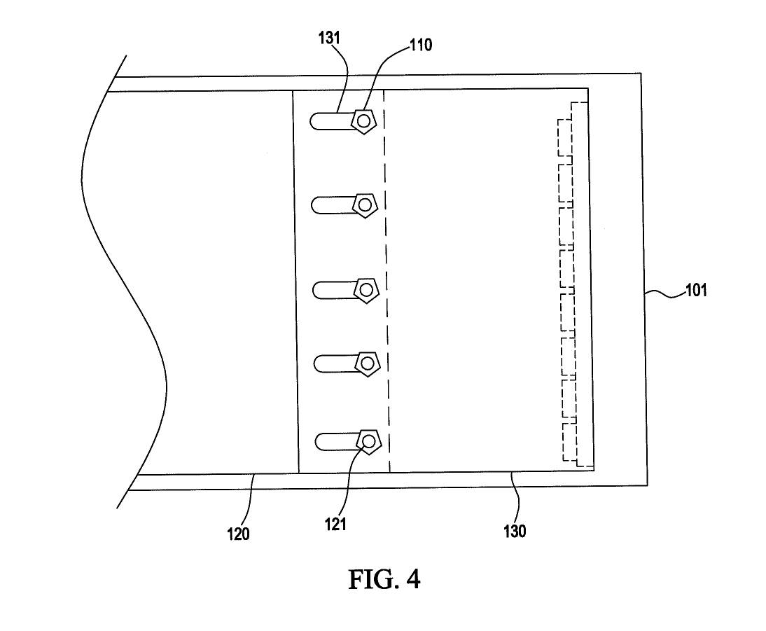

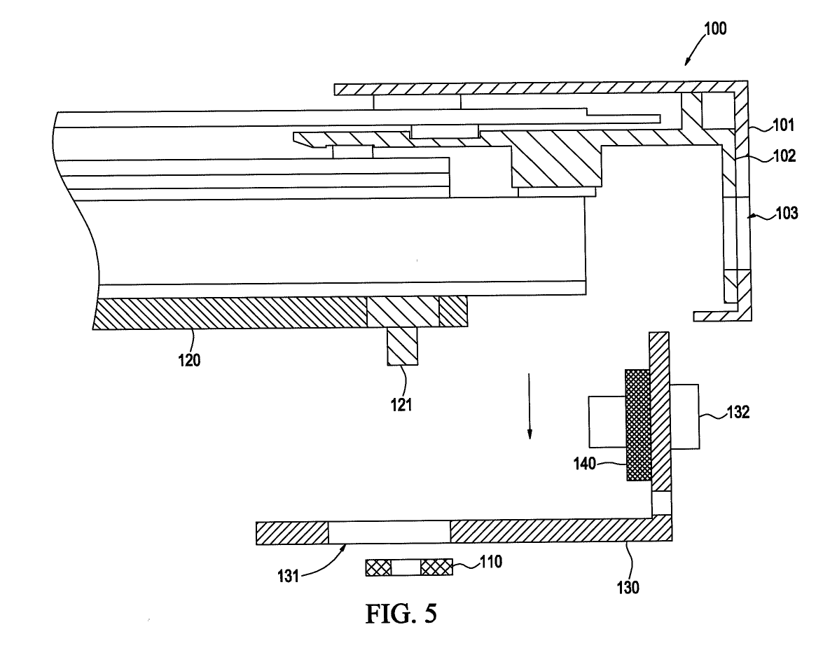

Please refer to FIGS. 3, 4 and 5, when the LED strip 140 is damaged or needs to be reworked, the reverse procedure is performed. The protrusion 132 of the Al extrusion type back plate 130 is pushed inward (left direction), such that the protrusion 132 is released from the frame 101 and the opening 103 of the bezel 102 (as shown in FIG. 3). Then, the Al extrusion type back plate 130 is moved to the left, and the track grooves 131 is also shifted to the left relative to the locking member (nut) (as shown in FIG. 4). And then, the locking member (nut) 110 is released and coming off the bolt 121, such that the Al extrusion type back plate 130 can be separated from the LCD 100 (as shown in FIG. 5). Thereby, LED strips 140 can be easily replaced, so as to achieve the purpose of high efficiency.

The previous description of the preferred embodiment is provided to further describe the present invention, not intended to limit the present invention. Any modification apparent to those skilled in the art according to the disclosure within the scope will be construed as being included in the present invention.

What is claimed is:

1. A back plate structure used in a liquid crystal display (LCD), comprising:
a plurality of locking members;
a fixed type metal back plate, disposed with a plurality of bolts; and
a detachable metal back plate, including a plurality of protrusions and a plurality of grooves, the plurality of protrusions are located on lateral sides of the detachable metal back plate and corresponding to positions of openings in a frame of the LCD so as to allow the protrusions to insert into the openings of the frame, and the grooves are corresponding to positions of the bolts so as to allow the bolts to insert into the grooves, and the fixed type metal back plate and the detachable metal back plate are fixed together through the locking members.

2. The back plate structure as claimed in claim 1, wherein the fixed type metal back plate is made of a SECC galvanized steel.

3. The back plate structure as claimed in claim 1, wherein the detachable metal back plate structure is made of an aluminum extrusion material.

4. The back plate structure as claimed in claim 1, wherein the detachable metal back plate is disposed with a lighting strip thereon.

5. The back plate structure as claimed in claim 1, wherein the groove is a track groove.

6. A liquid crystal display (LCD) including a frame and a back plate structure, the back plate structure comprising:
a plurality of locking members;
a fixed type metal back plate, disposed with a plurality of bolts; and
a detachable metal back plate, comprising a plurality of protrusions and a plurality of grooves, wherein the protrusions are located on lateral sides of the detachable metal back plate and corresponding to positions of openings of the frame so as to allow the protrusions to insert into the openings, and the fixed type metal back plate and the detachable metal back plate are fixed together through the locking members.

7. The LCD as claimed in claim 6, wherein the frame further includes a bezel, the bezel has a supporting arm to support the detachable metal back plate.

8. The LCD as claimed in claim 7, wherein the plurality of protrusions are inserted into the frame and openings of the bezel.

9. The LCD as claimed in claim 6, wherein the detachable metal back plate is disposed with a lighting strip thereon.

10. The LCD as claimed in claim 6, wherein the fixed type metal back plate is made of a SECC galvanized steel, and the detachable metal back plate structure is made of an aluminum extrusion material.
